(19) United States
(12) Patent Application Publication
(10) Pub. No.: US 2018/0200771 A1
(43) Pub. Date: Jul. 19, 2018

(54) PIPE CUTTING SYSTEM

(71) Applicant: Roundel Civil Products Pty Ltd, Neerabup (AU)

(72) Inventors: Graham Anthony Byard, Quindalup (AU); Justin Lance Mooney, Clarkson (AU)

(21) Appl. No.: 15/744,333

(22) PCT Filed: Jul. 13, 2016
(86) PCT No.: PCT/AU2016/050609

§ 371 Date: Jan. 12, 2018

(30) Foreign Application Priority Data
Jul. 13, 2015 (AU) 2015902767

(51) Int. Cl. B21C 37/12; B23K 10/00; B23K 37/02

(52) U.S. Cl. CPC B21C 37/127; B23K 10/00; B26D 3/16; B23K 37/0211; B21C 37/124; B23K 37/0276

(57) ABSTRACT

A pipe cutting system (40) and method for cutting a helically wound steel pipe while the pipe is being moved in a direction (12) of its longitudinal axis uses a plasma torch (50) supported to be reciprocally movable parallel to the longitudinal axis and at an orientation relative to the pipe so that a plasma jet emitted by the plasma torch is directed upwardly toward the pipe. The plasma torch is arranged move at a speed that is synchronised with a speed at which the pipe is being moved in the direction of the longitudinal axis. The pipe is rotated during cutting so that the plasma torch circumferentially cuts the pipe while the pipe is being moved.

### FIELD OF INVENTION

The present invention relates to a pipe cutting system.

The pipe cutting system may be use with, for example, but not exclusively, a steel pipe mill and more particularly a corrugate steel pipe mill.

### BACKGROUND ART

Steel pipe mills are used to form helically wound pipes or culverts (also referred to herein generally as “spiral pipe”) by bending feed stock in the form of sheet material into a spiral and joining the opposed sides of the sheet material. Once a desired length of spiral pipe has been formed, a section of the spiral pipe is circumferentially cut off before further spiral pipe is formed.

The known steel pipe mills utilise a flying shear cutting device to cut off the formed section of the spiral pipe from the feed stock. The cutting device may take the form of high tensile steel friction blades that cut/grind through the spiral pipe. However, such cutting inevitably leaves a burr about the cut circumferential edge of the spiral pipe. This burr will be prevalent on both ends of the spiral pipe. Leaving the burr in place is dangerous as it is normally sharp and projects outwardly from the spiral pipe, thus the burr can easily cut or injure a person handling the spiral pipe. Additionally the cutting blades require continuous maintenance by way of resharpening and, generate substantial levels of noise which often require mitigation in order to meet Occupational Health & Safety standards.

To avoid the possibility of such injury it is necessary to remove the burr, e.g. by grinding it off to produce a clean edge. It may also be necessary to paint the cut edge with a protective paint. In many production facilities, this finishing work often requires the employment of at least two additional operators and also additional de-burring machinery, which increases the manufacturing cost of the spiral pipe.

The above described background art is not intended to limit the application of the pipe cutting system as disclosed herein.

### SUMMARY OF THE INVENTION

According to a first aspect of the present invention, there is provided a pipe cutting system for cutting a pipe while the pipe is being moved in a direction of its longitudinal axis, the pipe cutting system comprising:

a plasma torch movably supported to be reciprocally movable parallel to the longitudinal axis;

wherein the plasma torch is capable of circumferentially cutting the pipe while the pipe is being moved.

The plasma torch may be arranged to be moved at a speed that is synchronised with a speed at which the pipe is being moved in the direction of the longitudinal axis.

The plasma torch may be supported in an orientation so that in use a plasma jet emitted by the plasma torch is directed upwardly.

According to a second aspect of the present invention A pipe cutting system for cutting a pipe while the pipe is being moved in a direction of its longitudinal axis, the pipe cutting system comprising:

a plasma torch movably supported to be reciprocally movable parallel to the longitudinal axis and at an orientation relative to the pipe so that in use a plasma jet emitted by the plasma torch is directed upwardly toward the pipe, the plasma torch being arranged to be moved at a speed that is synchronised with a speed at which the pipe is being moved in the direction of the longitudinal axis;

wherein the plasma torch is capable of circumferentially cutting the pipe while the pipe is being moved.

The plasma torch may be capable of circumferentially cutting the pipe in a plane substantially perpendicular to the longitudinal axis.

A pipe cutting system may comprise a proximity sensing system which measures the proximity of the plasma torch to an exterior surface of the spiral pipe and facilitates adjustment of a distance between the plasma torch and the exterior surface to maintain a predetermined clearance gap.

The plasma torch may be pivotally supported to be pivotal in a plane transverse to the longitudinal axis.

The plasma torch may be supported to be movable in a direction transverse to the longitudinal axis, thereby enabling the plasma torch to be moved closer to or further away from the pipe during use to control a clearance gap between the plasma torch and the pipe.

The plasma torch may be supported to be movable in a direction perpendicular to the longitudinal axis.

According to a third aspect the present invention provides a pipe cutting system for cutting a pipe while the pipe is being moved in a direction of its longitudinal axis, the pipe cutting system comprising:

a plasma torch movably supported to be reciprocally movable parallel to the longitudinal axis;

wherein the plasma torch is capable of circumferentially cutting the pipe while the pipe is being moved and wherein the plasma torch is supported to be movable in a direction transverse to the longitudinal axis, thereby enabling the plasma torch to be moved closer to or further away from the pipe during use to control a clearance gap between the plasma torch and the pipe; and a proximity sensing system which measures the proximity of the plasma torch to an exterior surface of the spiral pipe and facilitates adjustment of a distance between the plasma torch and the exterior surface to maintain clearance gap at a predetermined distance or within a range of distances.

The proximity sensing system may comprise a voltmeter arranged to measure a voltage across the clearance gap, wherein the plasma torch is arranged to be moved to reduce the clearance gap if the voltage exceeds a set-point voltage or voltage range, and to enlarge the clearance gap if the voltage is below set-point voltage or voltage range.

The pipe cutting system may comprise a first proximity sensor and a second proximity sensor, both proximity sensors being arranged to progressively sense the passing of a leading end of the pipe.

The first proximity sensor and the second proximity sensor may be spaced apart from each other by a distance of 200-300 mm.

The pipe cutting system may comprise a support frame having a rail onto which the plasma torch is movably mounted.

The rail may be an elongated slot extending along the support frame.

The rail may be a track extending along the support frame.

The pipe cutting system may be arranged for use with a steel pipe mill having a run-off table onto which pipe formed by the pipe forming machine is fed, wherein the plasma torch is located beneath the run-off table to restrict access to the plasma torch.

The plasma torch may be substantially enclosed within a space beneath the run-off table during use, the space being enclosed by the run-off table and the pipe when the pipe is located on the run-off table.

The pipe cutting system may be arranged for use with a steel pipe mill having a run-off table onto which spiral pipe formed by the steel pipe mill is rotatably fed, wherein the plasma torch is arranged to circumferentially cut the spiral pipe while the spiral pipe is being rotated.

The steel pipe mill may be a corrugate steel pipe mill capable of producing helically wound steel pipes or culverts.

According to a fourth aspect of the present invention, there is provided a method of cutting a pipe while the pipe is being moved in a direction of its longitudinal axis, the method comprising the steps of:

supporting a plasma torch adjacent to the pipe;

determining when a desired length of pipe has been formed;

rotating the pipe relative to the plasma torch while moving the plasma torch parallel to the longitudinal axis; and

energising the plasma torch so that the plasma torch circumferentially cuts the pipe while the pipe is being moved.

According to a fifth aspect of the present invention, there is provided a method of forming a helically wound steel pipe comprising:

operating a steel pipe mill to produce a helically wound steel pipe having a longitudinal axis;

feeding the helically wound steel in a direction of its longitudinal axis one a pipe support structure;

supporting a plasma torch adjacent to the pipe;

determining when a desired length of pipe has been formed;

rotating the pipe relative to the plasma torch while moving the plasma torch parallel to the longitudinal axis; and

energising the plasma torch so that the plasma torch circumferentially cuts the pipe while the pipe is being moved.

The method may comprise supporting a plasma torch adjacent to the pipe in an orientation such that a plasma jet emitted by the plasma torch is directed upwardly toward the pipe.

The method may comprise the step of synchronising movement of the plasma torch with movement of the pipe so that they move parallel to the longitudinal axis at the same speed.

The method may comprise the step of moving the plasma torch in a direction transverse to the longitudinal axis while the plasma torch is cutting the pipe so as to enable control a clearance gap between the plasma torch and the pipe.

The method may comprise sensing a distance between the plasma torch and an exterior surface of the pipe, and moving the plasma torch in the direction transverse to the longitudinal axis to maintain the clearance gap at a predetermined distance or within a range of distances.

Sensing the distance between the plasma torch and an exterior surface of the pipe may comprise measuring a voltage across the clearance gap and wherein the plasma torch is moved to: reduce the clearance gap if the voltage is above a set-point voltage or voltage range; and enlarge the clearance gap if the voltage is below a set-point voltage or voltage range.

The method may comprise the step of turning off the plasma torch when cutting of the pipe is completed, of moving the plasma torch away from the pipe in a direction transverse to the longitudinal axis, and of returning the plasma torch to a starting position.

The method may comprise the steps of providing a first proximity sensor and a second proximity sensor, both proximity sensors being arranged to sense the passing of a forward terminal end of the, of slowing down a speed at which the pipe is being moved in the direction of the longitudinal axis when the forward terminal end passes beyond the first proximity sensor, and of energising the plasma torch only after the forward terminal end passes beyond the second proximity sensor.

In the method the pipe being cut may comprise a corrugated helically wound steel pipe.

### BRIEF DESCRIPTION OF DRAWINGS

An embodiment of the present invention will now be described, by way of example, with reference to the accompanying schematic drawings, in which:

FIG. 1 is a perspective view of a run out table for a steel pipe mill being provided with a pipe cutting system according to an embodiment of the invention;

FIG. 2 is a right side view of the run out table seen along arrow II in FIG. 1;

FIG. 3 is an end view of the run out table seen along arrow III in FIG. 1;

FIG. 4 is a top plan view of the run out table seen along arrow IV in FIG. 3;

FIG. 5 is a perspective view of the pipe cutting system shown in FIG. 1;

FIG. 6 is a left side view of the pipe cutting system seen along arrow VI in FIG. 5;

FIG. 7 is an end view of the pipe cutting system seen along arrow VII in FIG. 5; and

FIG. 8 is a bottom plan view of the pipe cutting system seen along arrow VIII in FIG. 6.

### DETAILED DESCRIPTION OF THE DRAWINGS

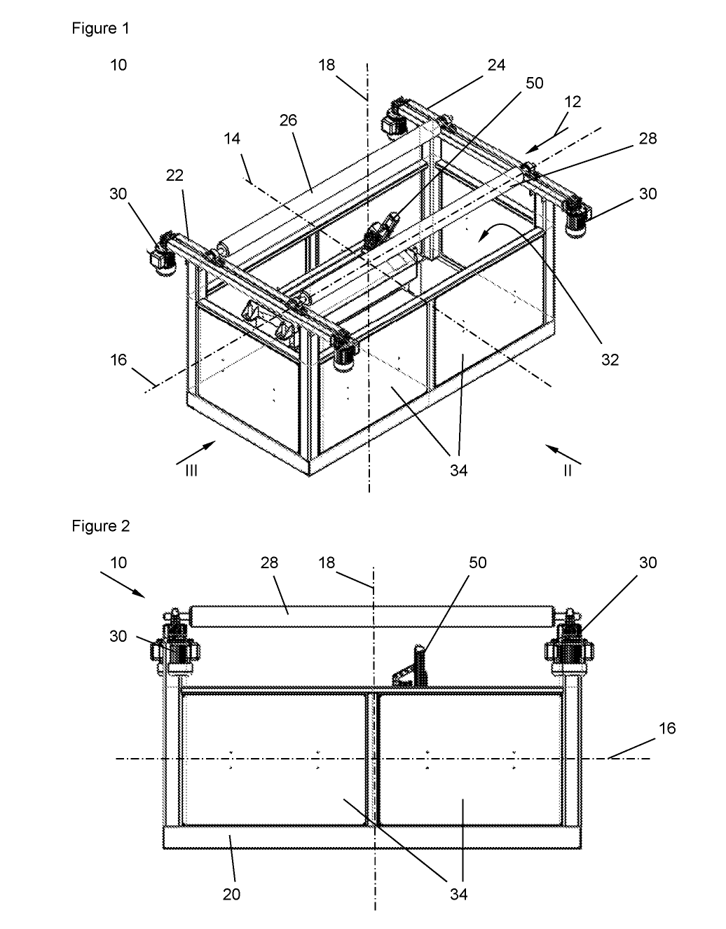

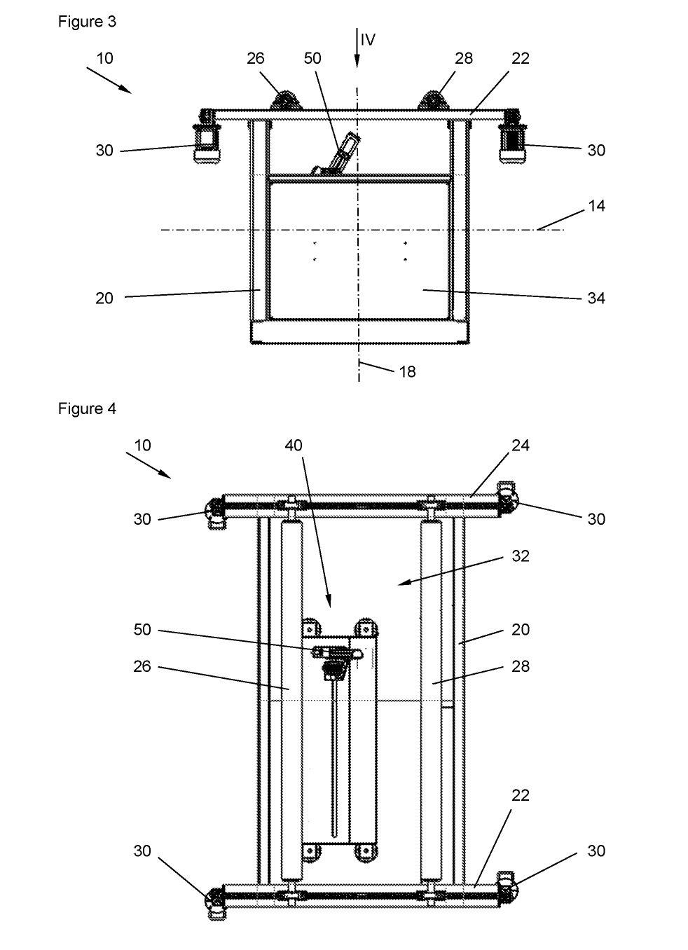

Referring to FIGS. 1 to 4 of the drawings, there is shown a pipe support structure in the form of a run-off table 10 associated with a steel pipe mill (not shown). The run-off table 10 is adapted to receive spiral pipe formed by the steel pipe mill wherein the spiral pipe is fed in a longitudinal direction along the run-off table 10 in a direction indicated by arrow 12.

According to standard directional convention, the run-off table 10 has a transverse x-axis 14 extending side-to-side across the run-off table 10, a longitudinal y-axis 16 extending along the length of the run-off table 10, and a vertical z-axis 18 extending upwardly through the run-off table 10.

The run-off table 10 includes a rectangular frame 20 that supports elongated guide brackets 22, 24 at either end thereof. The guide brackets 22, 24 are orientated parallel to each other and extend transversely across the frame 20 parallel to its x-axis 14. The guide brackets 22, 24 are arranged to movably support two spaced apart rollers 26, 28 that are longitudinally aligned along the run-off table 10. The rollers 26, 28 can be moved closer together to cater for spiral pipe having a smaller diameter or the rollers 26, 28 can be moved further apart to cater for spiral pipe having a larger diameter. The movement of the rollers 26, 28 is regulated by adjustment motors 30 that are mounted at the respective opposed ends of each guide bracket 22, 24.

The frame 20 defines an internal space 32 beneath the rollers 26, 28 in which is located a pipe cutting system 40 in accordance with an embodiment of the invention. The frame 20 is further provided with a number of removable side covers 34 extending peripherally around the frame 20 to close off side access to the space 32 and thereby restrict access to the pipe cutting system 40.

In use, spiral pipe is formed by the steel pipe mill in a conventional manner by continuously feeding in sheet material from a supply coil and corrugating the sheet material via a series of progressive formers to fold over the outer sides thereof to form interlockable flanges. Subsequently a forming head with an adjustable buttress causes the formed sheet material to curve spirally and form a helix enabling the interlockable flanges to be engaged with each other to form a lockseam. Initially the flanges are manually engaged, but after initial setup the steel pipe mill later automatically engages the flanges. Lastly a seaming die compresses the lockseam, creating a watertight seam and forming the spiral pipe while the pipe is being rotated about its longitudinal axis. As the spiral pipe is formed, it is fed out from the steel pipe mill onto the run-off table 10 in the direction of arrow 12. Once a desired length of spiral pipe has been formed, e.g. extending along the full length of the run-off table 10, a section of the spiral pipe is cut off by the pipe cutting system 40 and transferred to a dump table (not shown) for undergoing further processing or for transport to storage.

It will be appreciated that the pipe support structure/run-off table 10 can be increased in length along the y-axis 16 to accommodate the making of longer sections of spiral pipe. Alternatively, additional run-off tables 10 can be placed end on end for receiving longer sections of the spiral pipe.

Some steel pipe mills are arranged to form a spiral pipe having a smooth sidewall, i.e. having a constant outer diameter, whereas other steel pipe mills are arranged to form a spiral pipe have a corrugated sidewall, i.e. having a regular variable outer diameter, to provide improved rigidity and strength in the sidewall.

A processing unit controls the operation of both the steel pipe mill and the pipe cutting system 40. The processing unit has a user interface with a display screen for an operator to input requisite settings and dimensions related to the type and size of spiral pipe to be formed. However in an alternate embodiment the pipe cutting system 40 and the steel pipe mill may have respective processing units which communicate with each other in order to coordinate the cutting and manufacture of the spiral pipe.

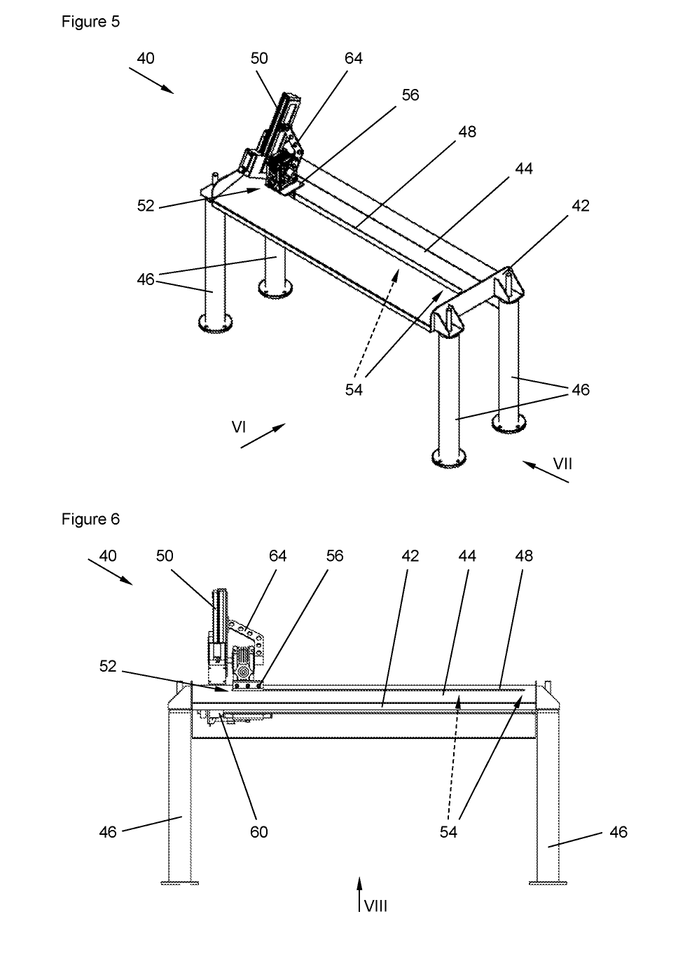

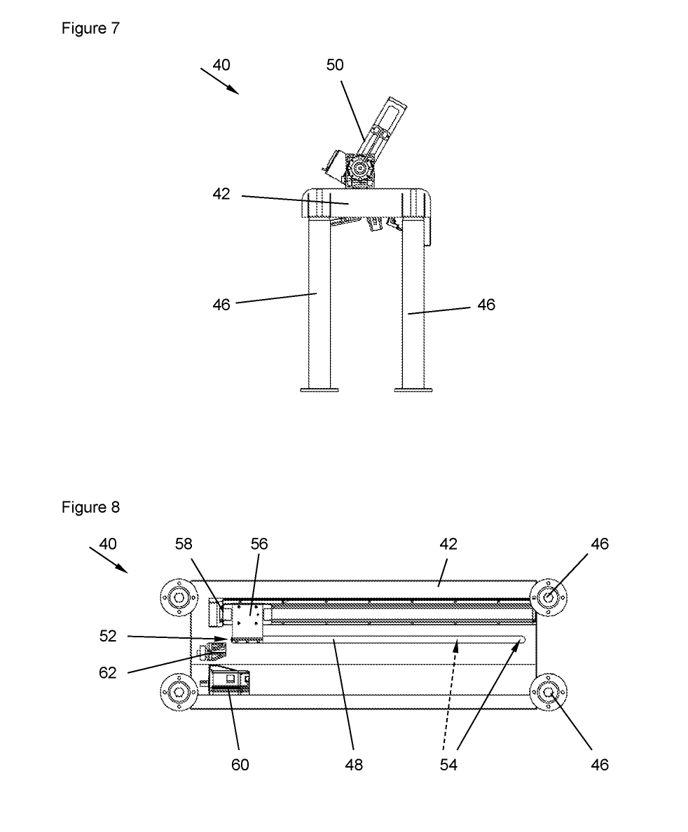

The pipe cutting system 40 is more clearly illustrated in FIGS. 5 to 8. The pipe cutting system 40 includes a support frame in the form of a table 42 having a sloped table top 44 supported by four table legs 46. As can be more clearly seen in FIG. 5, the table top 44 is in an inverted V-shape (when seen in end view) that slopes downwardly towards opposed sides of the table 42. In use, any debris or metal fragments shed by the spiral pipe during cutting thereof is urged by gravity to slide off the table top 44 onto a supporting floor surface for easy cleaning.

The table top 44 has a rail 48 that extends in a direction of the y-axis 16. As shown in the exemplary embodiment, the rail 48 is in the form of an elongated slot provided in the table top 44. However, in an alternative embodiment the rail 48 can be a discrete track mounted onto the table top 44. The provision of a slot is preferred as it permits easier cleaning and shedding of debris that may accumulate during use of the steel pipe mill and the pipe cutting system 40, as will be described in due course. It is envisaged that the rail 48 will have a length of ½-1 meter.

The rail 48 movably supports a plasma torch 50 so that the plasma torch 50 can reciprocally move along the rail 48 in the direction of the y-axis 16 between a first end point 52 located proximal to the steel pipe mill and a second end point 54 located distal to the steel pipe mill. In FIGS. 5 to 8 the plasma torch 50 is shown located at the first end point 52. A home limit switch (not shown) can be provided at the first end point 52, which switch is arranged to be toggled by the plasma torch 50 when located at the first end point 52.

The plasma torch 50 is mounted on a mounting plate 56, which is operatively engaged with a lead screw 58. The lead screw 58 is rotatably driven by motor 60. In use, rotation of the lead screw 58 in a forward direction causes the mounting plate 56, and thus the plasma torch 50, to move towards the second end point 54, whereas rotation of the lead screw 58 in a reverse direction causes the mounting plate 56, and thus the plasma torch 50, to move towards the first end point 52. A gearbox 62 is provided to regulate the speed and direction of rotation of the lead screw 58.

The plasma torch 50 is pivotally mounted on the mounting plate 56 to enable the plasma torch 50 to pivot about the y-axis 16, (i.e. in a plane containing the x and z axes) thereby to permit angle adjustment of the plasma torch 50 so that during use it can be oriented to aim at a desired point on a spiral pipe supported on the rollers 26, 28. The plasma torch 50 is able to pivot through an arc of about 45° from the z-axis 18. A support arm 64 extends between the mounting plate 56 and the plasma torch 50 to provide additional stability to the plasma torch 50 so that it does not become loose during the reciprocal movement along the rail 48 and deviate from its desired orientation.

The plasma torch 50 is further movable in a direction transverse to the longitudinal axis, e.g. vertically adjustable in the direction of the z-axis 18, so that it can be moved into an operative position and wherein the operative position can be adjusted during use to be closer to or further away from a spiral pipe supported on the rollers 26, 28. Such vertical adjustment enables a predetermined clearance gap to be maintained between the plasma torch 50 and the spiral pipe being cut thereby to accommodate for corrugations in the spiral pipe or variations in the degree of roundness of the pipe or otherwise to maintain a substantially constant clearance gap between a tip of the plasma torch 50 and the outer circumferential surface of the sidewall of the spiral pipe. When non-operative, e.g. before cutting commences or after cutting has been completed, the transverse movement allows the plasma torch 50 to be lowered to a “home” or “rest” position so that it does not interfere with any spiral pipe located on the rollers 26, 28 while the plasma torch 50 is returned to the first end point 52.

In one embodiment the pipe cutting system 40 further includes first and second pipe proximity sensors that are located remotely from the table 42 and adjacent to the run-off table 10 distal from the steel pipe mill. The proximity sensors are adapted to sense the passing of a leading end of the spiral pipe as it is being formed and to communicate this information to the processing unit. The processing unit is arranged to cause a reduction in the speed of operation of the steel pipe mill when the leading end passes the first proximity sensor and is further arranged to initiate cutting of the spiral pipe by the plasma torch 50 when the leading end passes the second proximity sensor. The proximity sensors are spaced apart from each other along the y-axis 16 by a distance of about 200-300 mm.

In use, when the spiral pipe is initially formed the leading end of the spiral pipe lies in an inclined plane to the vertical due to the forwardly projecting leading edge being spirally wound. It is thus necessary to perform an initial cut to square off the leading end to lie in the x-z plane. This initial cut can be controlled manually; where after the steel pipe mill is put into an automatic mode to continuously produce standard lengths of spiral pipe sections. During such production and depending on the diameter of the spiral pipe, the spiral pipe will normally progress along the run-off table 10 in the direction of the y-axis 16 at a linear output speed of 100-200 mm/sec while rotating about its longitudinal axis. Spiral pipes having a larger diameter normally have a higher linear output speed than those having a smaller diameter.

In an alternate embodiment the first and second sensors may be operatively connected with the processing unit to automatically control the feed of the spiral pipe to a location on the run-off table 10 where the initial cut to square off the spiral pipe is made. The processing unit may then control the plasma torch 50 and feed speed of the spiral pipe to automatically make the initial square off cut while the pipe is being rotated by the steel pipe mill. In this embodiment, after the automatic initial square off cut, processing unit controls the plasma torch 50 and feed speed in the manner otherwise described herein.

As mentioned above, when the leading end of the spiral pipe passes the first proximity sensor, the processing unit causes the steel pipe mill to reduce its output speed to a cutting speed, at which the spiral pipe progresses along the run-off table 10 at a speed of between about 20-75 mm/sec. The cutting speed is dependent on the thickness of the sidewall of the spiral pipe. It normally takes about 5-10 seconds for the spiral pipe to slow down and stabilise at the cutting speed. This delay interval can be adjusted by widening or narrowing the distance between the first proximity sensor and the second proximity sensor.

Once the spiral pipe is stabilised at the cutting speed, the leading end of the spiral pipe passes the second proximity sensor to initiate a cutting sequence to cut the spiral pipe with the plasma torch 50. The lead screw 58 is driven by motor 60 to rotate in a forward direction so that the plasma torch 50 undergoes linear travel along the rail 48 concurrently with the spiral pipe, whereby the linear travel speed of the plasma torch 50 is synchronised with the cutting speed of the spiral pipe.

Simultaneously the plasma torch 50 is moved vertically upwardly from its home position to an operative position. As soon as the linear travel speed is synchronised with the cutting speed, the plasma torch 50 is energised to produce a plasma jet for circumferentially cutting through the sidewall of the spiral pipe. During its linear travel, the plasma torch 50 is automatically adjusted up or down as needed to maintain a predetermined clearance gap between the plasma torch 50 and the sidewall of the spiral pipe, e.g. to make allowance for any corrugations in or changing thickness of the sidewall or variation in the roundness of the pipe. The clearance gap can be optimised for cutting efficiency in terms of cutting speed and/or power consumption. The extent of adjustment is determined by a proximity sensing system which measures the proximity of the plasma torch 50 to the exterior surface of the spiral pipe and then adjusts the distance between the plasma torch 50 and the exterior surface to maintain the clearance gap at a predetermined distance or within a predetermined range of distances. This may be done in a number of different ways including for example the use of optical sensors, ultrasonic sensors, capacitive sensors, inductive sensors, magnetic field sensors, or by measuring the arc voltage existing across the clearance gap between the plasma torch 50 and the sidewall. When for example arc voltage measurement is used, the sensor in the pipe cutting system 40 can be in the form of a voltmeter (not shown) for measuring the arc voltage. As the gap size increases, the voltage increases to compensate for the larger distance that the plasma jet must travel, and conversely the voltage decreases as the gap size decreases, thus enabling voltage to be used to sense the size of the clearance gap. Thus the plasma torch 50 is adjusted upwardly toward the spiral pipe if the voltage increases from a predetermined set-point voltage or voltage range, whereas the plasma torch 50 is adjusted downwardly away from the spiral pipe if the voltage decreases from the set-point voltage or voltage range.

The cutting by the plasma torch 50 continues until the spiral pipe has rotated through at least one full revolution on the run-off table 10 so that its sidewall is fully cut through along its circumference. The distance of linear travel required by the plasma torch 50 to reach the second end point 54 can be mathematically calculated and is a function of a diameter of the spiral pipe and a feeding speed of the sheet material. In most normal situations the linear travel distance will be ½-1 meter, but may occur within 620 mm-780 mm. Accordingly, the location of the second end point 54 is variable and is entered into the processing unit by an operator when setting up the steel pipe mill to produce spiral pipe with the desired diameter. However because the linear travel can be calculated mathematically the location of the second end point 54 can of course be determined and entered automatically by providing various sensor outputs to a software routine embedded in the processing unit.

Due to the orientation of the plasma torch 50, any debris created during cutting of the spiral pipe falls away from the spiral pipe and does not encumber the cutting process. Furthermore, the debris that is formed falls onto the sloped table top 44 and then subsequently slides down onto the floor. Accordingly the debris does not hinder movement of the plasma torch 50 along the rail 48 and can be easily swept up from the floor.

Finally, after the cut is completed and the plasma torch 50 has reached the second end point 54, the processing unit turns off the plasma torch 50 and lowers it from the operative position to the home position, where after the lead screw 58 is driven to rotate in a reverse direction to return the plasma torch 50 to the first end point 52 where it contacts the home limit switch. While the plasma torch 50 is being returned, the processing unit stops the production of spiral pipe for a short period (normally about 2 seconds) so that the cut off section of spiral pipe can be removed from the run-off table 10 and transferred to the dump table, where after production of a new section of spiral pipe commences. The transfer to the dump table can be done automatically or manually.

The location of the pipe cutting system 40 within the enclosed space 32 ensures safety of operational personnel as they cannot endanger themselves by coming into contact with the plasma torch 50 or the plasma jet. Also having the pipe cutting system 40 in an inverted orientation, namely whereby the plasma torch 50 cuts the spiral pipe from below, means that in use the spiral pipe forms a roof-like structure for the space 32 so that the pipe cutting system 40 is almost fully enclosed from all sides and above.

A further significant advantage of utilising the plasma torch 50 to cut the spiral pipe is that the plasma jet produces a smooth, burr-free edge at the cut end of the spiral pipe. This avoids the necessity for post-cut de-burring of the spiral pipe.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

For example, although the above description has throughout referred to spiral pipe formed on a steel pipe mill, the invention could equally be applied to other types of pipes made on other pipe forming machines.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1.-21. (canceled)

22. A corrugated pipe cutting system for cutting a corrugated pipe while the corrugated pipe is being moved in a direction of its longitudinal axis, the corrugated pipe cutting system comprising:
a plasma torch movably supported on a support frame to be reciprocally movable parallel to the longitudinal axis, the support frame supporting the plasma torch beneath the corrugated pipe so that in use a plasma jet emitted by the plasma torch is directed upwardly toward the corrugated pipe;
wherein the plasma torch is capable of circumferentially cutting the corrugated pipe while the corrugated pipe is being moved and wherein the plasma torch is supported to be movable in a direction transverse to the longitudinal axis, thereby enabling the plasma torch to be moved closer to or further away from the corrugated pipe during use to control a clearance gap between the plasma torch and the corrugated pipe; and a proximity sensing system which measures the proximity of the plasma torch to an exterior surface of the corrugated pipe and facilitates adjustment of a distance between the plasma torch and the exterior surface to maintain clearance gap at a predetermined distance or within a range of distances to accommodate for corrugations in the corrugated pipe.

23. The corrugated pipe cutting system according to claim 22 further comprising a processing unit, the processing unit operable to control the arranged to reduce an output speed of the corrugated pipe forming machine to a cutting speed wherein linear speed of travel of the plasma torch held to the longitudinal axis is synchronised with the cutting speed.

24. The corrugated pipe cutting system as claimed in claim 22, wherein the proximity sensing system comprises a voltmeter arranged to measure a voltage across the clearance gap, wherein the plasma torch is arranged to be moved to reduce the clearance gap if the voltage exceeds a set-point voltage or voltage range, and to enlarge the clearance gap if the voltage is below set-point voltage or voltage range.

25. The corrugated pipe cutting system as claimed in claim 22, comprising a first proximity sensor and a second proximity sensor, both proximity sensors being arranged to progressively sense the passing of a leading end of the corrugated pipe.

26. The corrugated pipe cutting system as claimed in claim 25, wherein the first proximity sensor and the second proximity sensor are spaced apart from each other by a distance of 200-300 mm.

27. The corrugated pipe cutting system as claimed in claim 22, wherein the support structure comprises a tabletop which is sloped downwardly on opposite sides of the plasma torch wherein debris shed by the corrugated pipe during cutting by the plasma cutter is urged by gravity to slide onto a floor surface.

28. The corrugated pipe cutting system as claimed in claim 27, wherein the plasma torch comprises a rail extending along the tabletop and along which the plasma torch is moved parallel to the longitudinal axis.

29. A method of cutting a corrugated pipe while the corrugated pipe is being moved in a direction of its longitudinal axis, the method comprising the steps of:
supporting a plasma torch adjacent to the corrugated pipe in an orientation such that a plasma jet emitted by the plasma torch is directed upwardly toward the corrugated pipe;
determining when a desired length of corrugated pipe has been formed;
rotating the corrugated pipe relative to the plasma torch while moving the plasma torch parallel to the longitudinal axis;
sensing a distance between the plasma torch and an exterior surface of the corrugated pipe, and moving the plasma torch in the direction transverse to the longitudinal axis to maintain the clearance gap at a predetermined distance or within a range of distances; and
energising the plasma torch so that the plasma torch circumferentially cuts the corrugated pipe while the corrugated pipe is being moved.

30. The method as claimed in claim 29 comprising the step of synchronising movement of the plasma torch with movement of the corrugated pipe so that they move parallel to the longitudinal axis at the same speed.

31. The method as claimed in claim 29, wherein sensing the distance between the plasma torch and an exterior surface of the corrugated pipe comprises measuring a voltage across the clearance gap and wherein the plasma torch is moved to reduce the clearance gap if the voltage is above a set-point voltage or voltage range to enlarge the clearance gap if the voltage is below a set-point voltage or voltage range.

32. The method as claimed in claim 29, comprising: of turning off the plasma torch when cutting of the corrugated pipe is completed; moving the plasma torch away from the corrugated pipe in a direction transverse to the longitudinal axis; and returning the plasma torch to a starting position.

33. The method as claimed in claim 29, comprising providing a first proximity sensor and a second proximity sensor, both proximity sensors being arranged to sense the passing of a leading end of the corrugated pipe, of slowing down a speed at which the pipe is being moved in the direction of the longitudinal axis when the leading end passes beyond the first proximity sensor, and of energising the plasma torch only after the leading end passes beyond the second proximity sensor.
